(19) United States
(12) Patent Application Publication
(10) Pub. No.: US 2013/0320705 A1
(43) Pub. Date: Dec. 5, 2013

(54) DOOR TRIM UPPER STRUCTURE

(71) Applicant: SUZUKI MOTOR CORPORATION, Shizuoka-ken (JP)

(72) Inventors: Kazuhiro Okada, Shizuoka-ken (JP); Goro Kinoshita, Shizuoka-ken (JP)

(73) Assignee: Suzuki Motor Corporation, Shizuoka-ken (JP)

(21) Appl. No.: 13/854,369

(22) Filed: Apr. 1, 2013

(30) Foreign Application Priority Data
Jun. 1, 2012 (JP) 2012-126317

(51) Int. Cl. B60J 10/00

(52) U.S. Cl. CPC B60J 10/0091
USPC 296/146.2

(57) ABSTRACT

There is provided a door trim upper structure in which the assembling ability is excellent, and also the sealability between the door trim upper structure and a weather strip is not impaired. In a door trim (3) having an upper edge (3a) projecting toward a door glass above the weather strip; a flange part (34) projecting from the distant position of the back surface with respect to the door glass so as to be seated on the upper surface of the attachment part; and a locking part (38) for locking the flange part to the attachment part, the locking part includes a lower locking part (35) extending below the flange part and an upper locking part (36) extending from the tip end of the flange part, and the attachment part is held between the lower locking part and the upper locking part.

### RELATED APPLICATION

This application claims priority from Japanese Patent Application No. 2012-126317, filed Jun. 1, 2012, the disclosure of which is incorporated by reference herein in its entirety.

### FIELD AND BACKGROUND OF THE INVENTION

The present invention relates to a door trim upper structure and, more particularly, to an attachment structure near a door trim upper end to a weather strip on the indoor side of a door.

A weather strip that is provided to prevent the intrusion of water into a vehicle compartment and to retain the sound insulating properties is a part that is important for regulating the position with respect to peripheral parts to ensure the adhesion to a window glass. In particular, the weather strip attached to the door panel upper end that defines the lower side of a door window opening vibrates on account of friction along with the operation of a door glass, and also must ensure sealability even between the weather strip and the door trim upper end.

On the other hand, a door trim upper portion on the inside of the vehicle compartment is a part that is touched by the passengers. If the position of the weather strip is shifted by elastic deformation caused by the touch with a passenger, the sealability of the weather strip may be impaired. Even if the weather strip attaching structure is merely strong, a load applied to the door trim upper portion is transmitted directly to the weather strip attaching portion, which produces a contrary result, and also the assembling ability may be impaired.

### SUMMARY OF THE INVENTION

The present invention has been made in view of the above situation, and accordingly, an object thereof is to provide a door trim upper structure in which the assembling ability is excellent, and also the sealability between the door trim upper structure and a weather strip is not impaired.

To solve the problems with the prior art, the present invention provides a door trim upper structure including a weather strip (4) attached to the upper end (14a) of a door inner panel (14), which defines the lower side of window opening of a vehicular door, to seal a gap between the upper end and a door glass (2), the weather strip having a base part (40) capable of being fitted on the upper end; at least one lip part (41, 42) extending from the base part to the door glass side; and an attachment part (44) projecting from the base part to the indoor side, and having a substantially uniform cross section in the lengthwise direction along the upper end; and a door trim (3) covering the indoor side of the door inner panel (14), which has an upper edge (3a) projecting toward the door glass above the weather strip; a flange part (34) projecting from the distant position of the back surface with respect to the door glass so as to be seated on the upper surface of the attachment part; and a locking part (38) for locking the flange part to the attachment part, wherein the locking part includes a lower locking part (35) extending below the flange part and an upper locking part (36) extending from the tip end of the flange part, so that the attachment part (44) is held between the lower locking part and the upper locking part.

As described above, the door trim upper structure is configured so that the flange part that separates from the upper edge of the door trim is placed on the attachment part separated from the lip part of the weather strip, and the attachment part is held between the upper and lower locking parts. Therefore, the attachment part and the lip part of the weather strip are not influenced by a load applied to the door trim upper portion, and the sealability between the weather strip and the door glass is not impaired. Also, since the attachment structure (the flange part, the upper and lower locking parts) on the door trim side is separate from the upper edge of the door trim, the assembling ability is excellent although the attachment structure lies at a position of being hidden by the upper edge of the door trim.

In a preferred mode of the present invention, the lower locking part (35) and the upper locking part (36) each are provided in plural numbers so as to be separated from each other in the lengthwise direction along the upper edge (14a) of the door inner panel, and the lower locking parts and upper locking parts are arranged in a staggered manner to each other in the lengthwise direction. In this mode, the intervals between the upper and lower locking parts are kept not only in the thickness direction of the attachment part of the weather strip but also in the lengthwise direction thereof. Therefore, the attachment part of the weather strip can be easily inserted and locked between the upper and lower locking parts, so that this mode is advantageous in improving the assembling ability. Also, as compared with the case in which the upper and lower locking parts are arranged at the same position, in the lengthwise direction of the attachment part of the weather strip, the number of contact points with the locking parts on the door trim side increases. Therefore, in addition to the stabilization of attached state, many contact points can be obtained by substantially less labor, so that this mode is also advantageous in terms of assembling ability.

In another preferred mode of the present invention, three or more sets of the locking structure parts (38) are arranged in the lengthwise direction along the upper end of the door inner panel; each set of the locking structure part is formed by one lower locking part (35) and two upper locking parts (36) disposed on both sides of the lower locking part, or by one upper locking part (36) and two lower locking parts (36) disposed on both sides of the upper locking part; and among these three or more sets of the locking structure parts, the locking structure parts located in the intermediate portions in the lengthwise direction each are disposed at a slightly higher position as compared with the locking structure parts located on both sides in the lengthwise direction. In this mode, in addition to the above-described effects, the symmetry of each locking structure part is ensured, and stable locking can be performed. Also, the weather strip can be caused to have a very slight (invisible) arch-form stress distribution in the lengthwise direction in advance. Thereby, the sag of the weather strip in the state of being assembled for a long period of time can be prevented, and in addition, by the above-described stress distribution, the reduction in the friction between the seal part of the weather strip and the door glass and the frictional vibrations can be anticipated, and also the improvement in draining properties can be anticipated.

In still another preferred mode of the present invention, at least one reinforcing rib (33) extending in the direction crossing the lengthwise direction along the upper end of the door inner panel is provided erect between the lower locking part (35) and the back surface of door trim. In this mode, the support rigidities of the flange part and the upper and lower locking parts and the strength of the door trim upper portion are improved, and the stability of the attachment part of weather strip against the load applied to the door trim upper portion is further improved.

As described above, the door trim upper structure in accordance with the present invention is advantageous in providing a door trim upper structure in which the assembling ability is excellent, and also the sealability between the door trim upper structure and the weather strip is not impaired.

### BRIEF DESCRIPTION OF THE DRAWINGS

FIG. 1(a) is a side view of a vehicular door to which a door trim upper structure in accordance with the present invention is applied, as viewed from the indoor side, and

FIG. 1(b) is an exploded view of an essential portion of the vehicular door;

FIG. 2(a) is a perspective view of a door trim upper structure in accordance with an embodiment of the present invention, as viewed from the back surface side, and

FIG. 2(b) is a perspective view of an essential portion of the door trim upper structure, showing a state in which a weather strip is assembled;

FIG. 3 is a perspective view of a set of locking structure part for a door trim upper structure in accordance with an embodiment of the present invention; and

FIG. 4(a) is a sectional view taken along the line A-A of FIG. 3, FIG. 4(b) is a sectional view taken along the line B-B thereof, and FIG. 4(c) is a sectional view taken along the line C-C thereof.

### DESCRIPTION OF THE EMBODIMENTS OF THE INVENTION

The present invention now will be described more fully hereinafter in which embodiments of the invention are provided with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. Unless otherwise defined, all technical and scientific terms used herein have the same meaning as commonly understood by one of ordinary skill in the art to which this invention belongs. All references cited are incorporated herein by reference in their entirety. An embodiment of the present invention will now be described in detail with reference to the accompanying drawings.

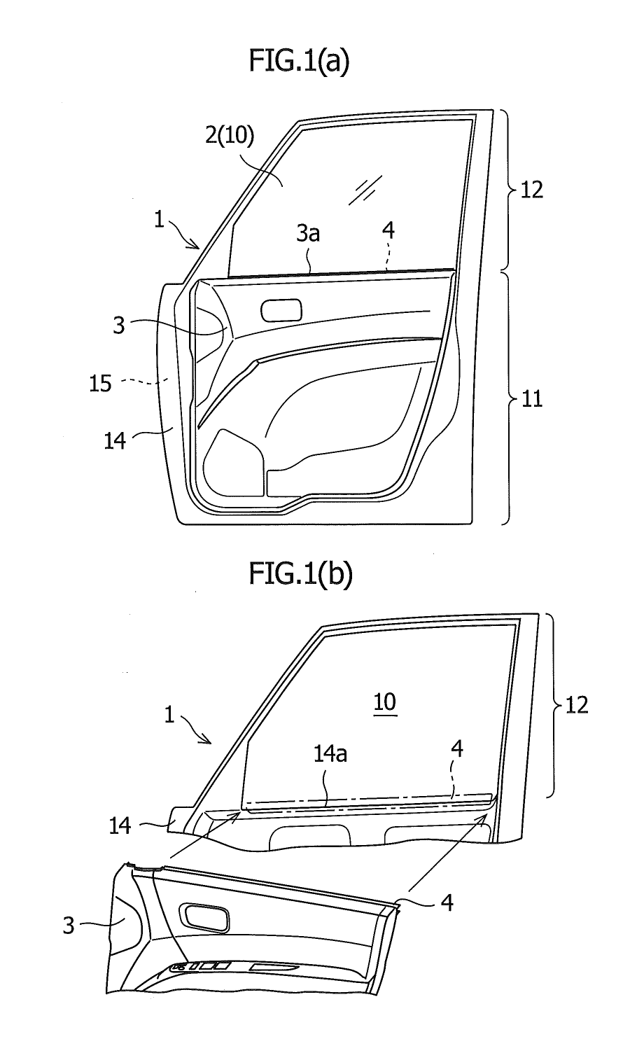

FIG. 1(a) is a side view of a vehicular door 1 (a front door) to which a door trim upper structure in accordance with the present invention is applied, as viewed from the indoor side, and FIG. 1(b) is an exploded view of an essential portion of the vehicular door 1. Referring to these figures, in the door 1, an outer panel 15 and an inner panel 14 are integrally joined in the peripheral edge portions of the panels 15 and 14, and a sash part 12 defining a window opening 10 is provided integrally above a door body part 11.

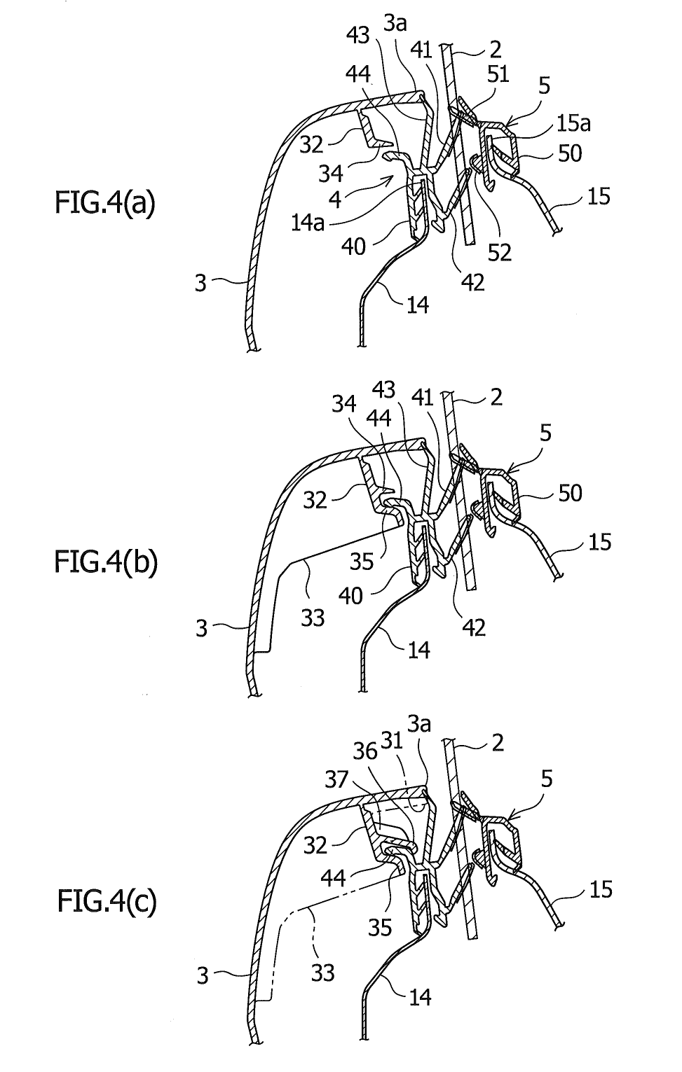

In the window opening 10 of the door 1, a window glass 2 is provided elevatably, and in upper ends 14a and 15a of the inner panel 14 and the outer panel 15, respectively, which upper ends 14a and 15a define the lower side of the window opening 10, weather strips 4 and 5 (refer to FIG. 4) for sealing the gap between the upper ends 14a and 15a and the window glass 2 are mounted, respectively. In some cases, the weather strip on the indoor side is referred to as an inner weather strip, and the weather strip on the outdoor side is referred to as an outer weather strip.

On the surface on the indoor side of the inner panel 14 in the door body part 11 is covered with a door trim 3. The door trim 3 is formed of an injection-molded plastic, and is fixed to the inner panel 14, although not shown, by inserting and locking a plurality of clips projectingly provided on the back surface side into and to holes in the inner panel 14. At this time, the upper portion of the door trim 3 is assembled to the weather strip 4. In the following, the weather strip 4 and the upper structure of the door trim 3 is explained in detail with reference to the drawings.

The weather strip 4 is formed of an extrusion-molded product of synthetic rubber, thermoplastic elastomer, or the like, as shown in FIG. 4, and has a base part 40 having a substantially U-shaped cross section, which can be fitted on an upper end 14a of the inner panel 14; two glass seal lips 41 and 42 extending from two upper and lower locations on the side surface of the base part 40 so as to tilt to the window glass 2 side; a trim seal lip 43 extending upward from the upper portion of the base part 40; and an attachment part 44 that extends upward from the upper portion of the base part 40, being bent, and projects to the indoor side. The weather strip 4 also takes a uniform cross-sectional shape in the lengthwise direction. The attachment part 44 serves as a part for attaching the upper portion of the door trim 3 to the weather strip 4.

The weather strip 5 on the outdoor side is configured in a similar way, that is, it has a base part 50 having a substantially U-shaped cross section, which can be fitted on an upper end 15a of the outer panel 15, and two glass seal lips 51 and 52 extending from the side surface of the base part 40 to the window glass 2 side, and takes a uniform cross-sectional shape in the lengthwise direction.

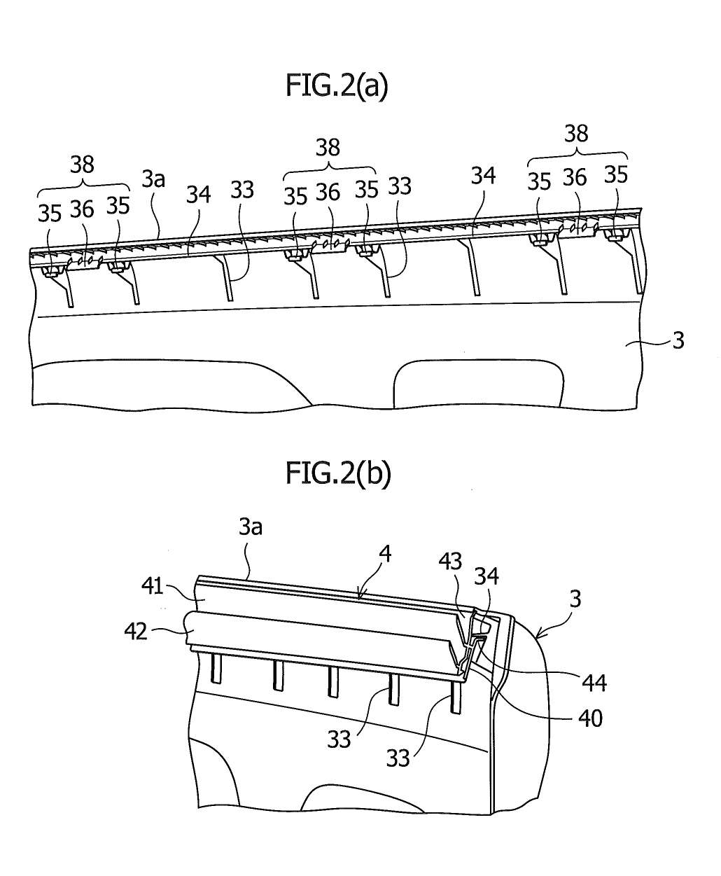

On the other hand, on the back surface side of the upper portion of the door trim 3, as shown in FIGS. 2 to 4, an assembling structure (34, 35, 36) opposed to the attachment part 44 of the weather strip 4 is formed integrally with the body portion of the door trim 3 by the above-described injection molded plastic. An upper edge 3a of the door trim 3 projects toward the window glass 2 in a portion somewhat above the weather strip 4, and from the distant position of the back surface with respect to the window glass 2 to the upper edge 3a, a longitudinal rib 32 extending in parallel with the upper edge 3a protrudes downward. A flange part 34 to be placed on the upper surface of the attachment part 44 projects from the lower end of the longitudinal rib 32 toward the attachment part 44.

As locking parts for locking the flange part 34 to the attachment part 44, a lower locking part 35 protruding under the flange part and an upper locking part 36 protruding from the tip end of the flange part 34 to the base portion of the attachment part 44 are formed integrally with the flange part 34. The tip end portion of the lower locking part 35 is curved downward to facilitate the introduction of the attachment part 44.

Also, the tip end portion of the upper locking part 36 is bent downward so as to go around to the back of the base portion of the attachment part 44. The configuration is made such that, in an assembled state, as shown in FIG. 4(c), the attachment part 44 is held between the lower locking part 35 and upper locking part 36, and also the upper edge 3a is pushed against the trim seal lip 43.

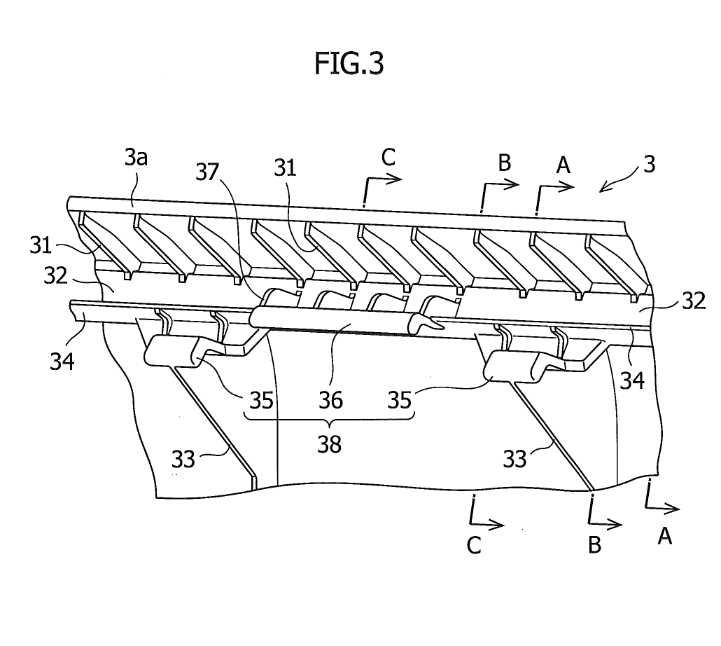

As shown in FIGS. 4(c) and 3, on the lower surface side of the upper edge 3a, a lot of ribs 31 for reinforcing the upper edge 3a are provided so as to extend in the direction crossing the lengthwise direction of the upper edge 3a. Also, a plurality of ribs 37 are provided so as to be erect from the upper surface of the upper locking part 36 toward the front faces of the longitudinal ribs 32

Furthermore, as shown in FIG. 4(b), a reinforcing rib 33 extending in the direction crossing the longitudinal rib 32 is erectingly provided between the back surface ranging from the lower locking part 35 to the longitudinal rib 35 and the back surface of the door trim 3. The longitudinal rib 32 and the reinforcing rib 33 form a base frame of the assembling structure (34, 35, 36) opposed to the attachment part 44 of the weather strip 4, and also form a reinforcing structure for the door trim upper portion.

The above-described lower locking part 35 and upper locking part 36 each are provided in plural numbers so as to be separated from each other in the lengthwise direction of the upper edge 3a, and the lower locking parts 35 and upper locking parts 36 are arranged in a staggered manner to each other in the lengthwise direction. Thereby, the intervals between the lower locking parts 35 and upper locking parts 36 are maintained not only in the thickness direction but also in the lengthwise direction of the attachment part 44, and the attachment part 44 can be easily inserted and locked between the lower locking parts 35 and upper locking parts 36.

Also, in the example shown in the drawings, one set of locking structure part 38 is configured by one upper locking part 36 and two lower locking parts 35 on both sides of the upper locking part 36. By this configuration, the symmetry of each locking structure part 38 is ensured, and stable locking can be performed.

Furthermore, three or more sets of locking structure parts 38 (three sets are shown in FIG. 2) each having the above-described symmetry are arranged in the lengthwise direction, and all of the locking structure parts 38 are not formed at the same position with respect to the flange part 34 extending in the lengthwise direction, but the locking structure parts 38 located in the intermediate positions in the lengthwise direction may be disposed at a slightly higher position as compared with the locking structure parts 38 located on both sides.

Thereby, the attachment part 44 locked by these three locking structure parts 38 is laid in a (invisibly) slight arch form in the lengthwise direction of the weather strip 4. Accordingly, the attachment part 44 can be caused to have an arch-form stress distribution in advance. Thereby, the sag of the weather strip 4 in the state of being assembled for a long period of time can be prevented, and in addition, by the arch-form layout, the reduction in the friction between the glass seal lips 41 and 42 of the weather strip 4 and the window glass 2 and the frictional vibrations can be anticipated, and also the improvement in draining properties can be anticipated.

In place of the configuration of one set of locking structure part 38 formed by one upper locking part 36 and two lower locking parts 35 on both sides of the upper locking part 36, one set of locking structure part 38 can be configured by one lower locking part 35 and two upper locking parts 36 on both sides of the lower locking part 35. In this case, the widths of the two upper locking parts 36 are narrowed, and the width of the one lower locking part 35 is widened. In effect, it is preferable that the total of the contact areas of upper and lower locking parts be made equivalent.

The above is a description of the embodiment of the present invention. The present invention is not limited to the above-described embodiment, and various modifications and changes can be made based on the technical concept of the present invention.

Having thus described certain embodiments of the present invention, it is to be understood that the invention defined by the appended claims is not to be limited by particular details set forth in the above description as many apparent variations thereof are possible without departing from the spirit or scope thereof as hereinafter claimed.

That which is claimed:

1. A door trim upper structure comprising:
a weather strip attached to a door inner panel upper end, which defines the lower side of window opening of a vehicular door, to seal a gap between the upper end and a door glass, the weather strip having: a base part capable of being fitted on the upper end; at least one lip part extending from the base part to the door glass side; and an attachment part projecting from the base part to the indoor side, and having a substantially uniform cross section in the lengthwise direction along the upper end; and
a door trim covering the indoor side of the door inner panel, the door trim having: an upper edge projecting toward the door glass above the weather strip; a flange part projecting from the distant position of the back surface with respect to the door glass so as to be seated on the upper surface of the attachment part; and a locking part for locking the flange part to the attachment part,
wherein the locking part includes a lower locking part extending below the flange part and an upper locking part extending from the tip end of the flange part, so that the attachment part is held between the lower locking part and the upper locking part.

2. The door trim upper structure according to claim 1, wherein the lower locking part and the upper locking part each are provided in plural numbers so as to be separated from each other in the lengthwise direction along the upper edge of the door inner panel, and the lower locking parts and upper locking parts are arranged in a staggered manner to each other in the lengthwise direction,

3. The door trim upper structure according to claim 1, wherein three or more sets of the locking structure parts are arranged in the lengthwise direction along the upper end of the door inner panel; each set of the locking structure part is formed by one lower locking part and two upper locking parts disposed on both sides of the lower locking part, or by one upper locking part and two lower locking parts disposed on both sides of the upper locking part; and among these three or more sets of the locking structure parts, the locking structure parts located in the intermediate portions in the lengthwise direction each are disposed at a slightly high position as compared with the locking structure parts located on both sides in the lengthwise direction.

4. The door trim upper structure according to claim 1, wherein, at least one reinforcing rib extending in the direction crossing the lengthwise direction along the upper end of the door inner panel is provided erect between the lower locking part and the back surface of door trim.
